(19) United States
(12) Patent Application Publication
(10) Pub. No.: US 2006/0150822 A1
(43) Pub. Date: Jul. 13, 2006

(54) Method for making espresso and device for the like

(76) Inventor: Chien-Wen Wu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/033,634

(22) Filed: Jan. 13, 2005

(51) Int. Cl. A47J 31/00

(52) U.S. Cl. 99/279

(57) ABSTRACT

A method for making espresso and a device for the like that uses a tamping device to tamp the ground coffee, and a filter that mates with a filter holder loosely so that the filter is easily attached and detached from the filter holder. Therefore, the filter can be kept cool and the filter holder can be preheated respectively for making excellent espresso.

### BACKGROUND OF THE INVENTION

1. Field of the Invention

The present invention relates to a method for making espresso and a device for the like, and particularly relates to a method for making espresso and a device for the like, which makes a perfect espresso easily.

2. Background of the Invention

During the evolution of the coffee machine last century, the Italians found a method for making coffee that created an emulsion of flavorful and aromatic oils combined with other chemical elements and suspended gas bubbles, which gives the concentrated flavor, velvety texture, and dark reddish-brown crema that today so distinguishes true Italian coffee. They did this by forcing highly pressurized, about 8-9 bars, hot water through coffee so that the water was in contact with the coffee grounds for a short time, ideally about 25 seconds.

Conventional methods for making espresso include the following steps: grinding, tamping, extraction processing and so on. The tamping step plays an important role because the water with high pressure is filtered. The pressure, which is responsible for the development of the crema, of the water is forced through the ground coffee so as to balance the resistance of the tamped ground coffee and the pressure of the water, in order to extract the espresso, thus creating an aromatic crema and strong taste.

The conventional tamping method is to fill the ground coffee into a filter. The ground coffee, then heaped in the filter, is pushed aside to form a flat and uniform surface, and a tamping device is used to press the coffee downwards and compact it. Using the filter holder as a lever to connect the filter to a group, so as to make the espresso with highly pressurized hot water.

However, the filter is secured to the filter holder by annulated buckling manner, so other tools must be used to disconnect the filter from the filter holder. In addition, in the process of making espresso, the filter holder and the filter have different temperatures; for example, the filter holder is preheated before making espresso, and the filter with the ground coffee is kept at room temperature to avoid the flavor of the coffee being released too early. Because it is difficult to attach and detach the filter to the filter holder as mentioned above, the filter cannot be kept cool in practice, so that the quality of the coffee cannot be guaranteed.

Furthermore, because it is difficult to detach the filter from the filter holder, the used filter is difficult to replace, and because it is often wet residues from the previously made cup of espresso will often still be attached, so as to influence the quality of the next cup of espresso.

The conventional method of making espresso uses a plastic tamping device to compact the ground coffee in the filter. However, if the ground coffee is tamped incorrectly, the concentrated flavor and the velvety texture are difficult to achieve. Furthermore, making espresso is really difficult for most people, and only experienced baristas can make an excellent espresso.

Hence, an improvement over the prior art is required to overcome the disadvantages thereof.

### SUMMARY OF INVENTION

A method for making espresso and a device for the like is provided to exclude variables in the process so that an excellent espresso can be made by an inexperienced person easily.

A method for making espresso includes the following steps:

(a) grinding coffee beans into ground coffee, and putting the ground coffee into a filter, which has a screen formed on a bottom thereof;

(b) tamping the ground coffee evenly via a tamping device; and

(c) arranging the filter to a filter holder in a loose mating manner, attaching the filter holder to a group of an espresso machine, and making the espresso by forcing highly pressurized hot water through the coffee grinds.

A device for making espresso includes:

a filter; and

a filter holder having a holding portion and a supporting portion connecting to an end of the holding portion, wherein the supporting portion has a slot formed on a top thereof, and an exit formed on a bottom thereof and communicating with the slot, the diameter of the slot is longer than that of the filter;

wherein the filter is arranged to the filter holder in a loose mating manner.

To provide a further understanding of the invention, the following detailed description illustrates embodiments and examples of the invention. Examples of the more important features of the invention have thus been summarized rather broadly in order that the detailed description thereof that follows may be better understood, and in order that the contributions to the art may be appreciated. There are, of course, additional features of the invention that will be described hereinafter which will form the subject of the claims appended hereto.

### BRIEF DESCRIPTION OF THE DRAWINGS

These and other features, aspects, and advantages of the present invention will become better understood with regard to the following description, appended claims, and accompanying drawings, where:

FIG. 1 is a flow chart of a method for making espresso according to the present invention;

FIG. 2 is a perspective view of an espresso machine with a grinding machine according to the present invention;

FIG. 3 is a perspective view of a tamping device according to the present invention;

FIG. 4 is a perspective view of the tamping device in use according to the present invention;

FIG. 5 is a decomposition view of the filter and the filter holder according to the present invention;

FIG. 6 is a perspective view of the filter and the filter holder according to the present invention; and

FIG. 7 is a decomposition view of a filter with no holes and the filter holder according to the present invention.

### DETAILED DESCRIPTION OF THE EMBODIMENTS

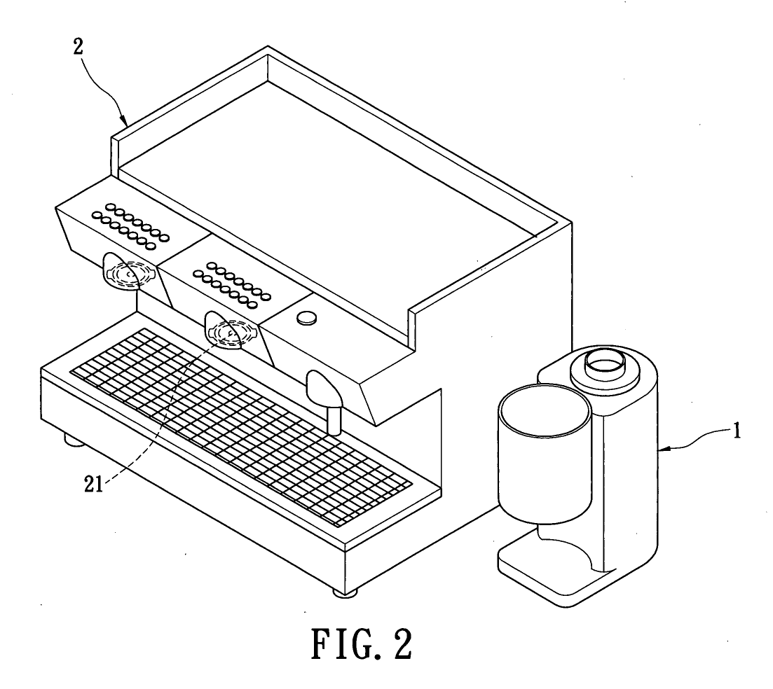

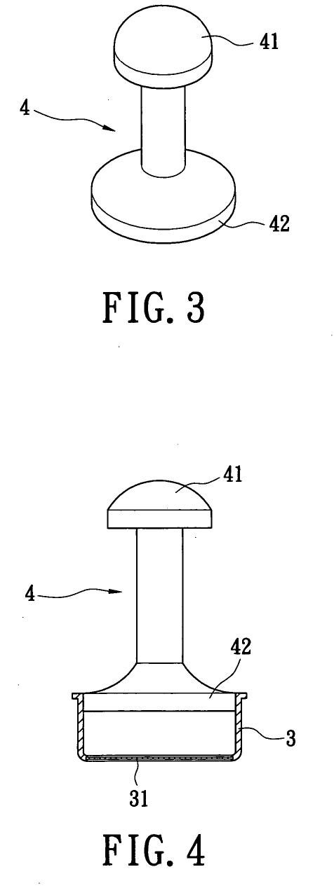

A method for making espresso and a device for the like are disclosed according to the present invention, the method is applied with a grinding machine 1 and an espresso machine 2, illustrated in FIG. 2. The grinding machine 1 grinds coffee beans into ground coffee, and the espresso machine includes at least one group 21, from which pressured hot water is provided. Because the grinding machine 1 and the espresso machine 2 are not the subject matters of the present invention, and the grinder machine 1 and the espresso machine 2 do not apply to the method for making espresso according to the present invention, they cannot be used to restrict the claims made in this application, and the detail descriptions of the grinder machine 1 and the espresso machine 2 will not be mentioned from hereon in. As such, and kind or brand of espresso machine or grinder machine may be used.

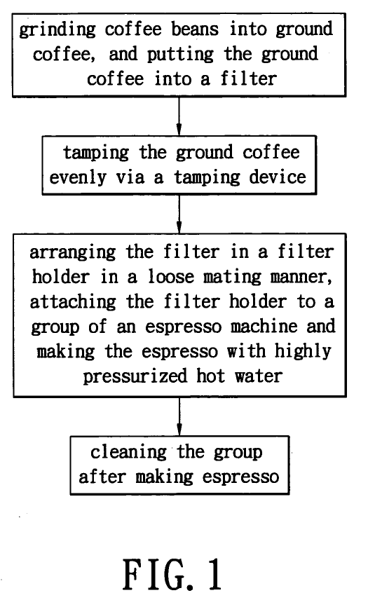

With respect to FIG. 1, the method includes the following steps:

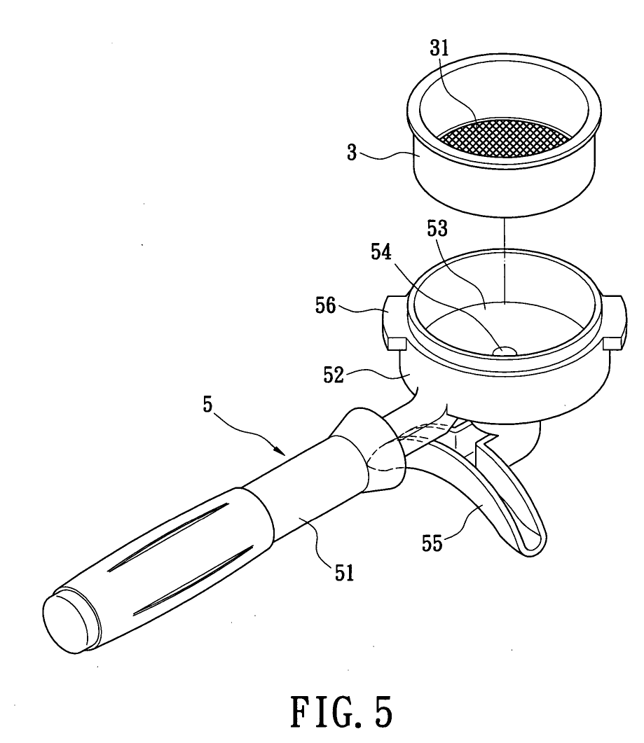

(a) A plurality of coffee beans are provided and further ground into ground coffee via the grinding machine 1, the ground coffee is then put into a filter 3, which has a screen 31 formed on a bottom thereof, in FIGS. 4 and 5.

The filter 3 is made of stainless steel, and has an opening formed at a top thereof, espresso flows out through the screen 31 after the hot water is forced through the ground coffee.

(b) The ground coffee is tamped evenly with a tamping device 4 (in FIG. 4). First the ground coffee is pushed aside to so that it becomes flat and uniform, and it is then pressed downwardly with the tamping device 4, and the tamping device 4 is rotated with a determined angle to form the ground coffee into a compact coffee mass. If the ground coffee is not tamped correctly, the water will be forced through the ground coffee too fast and the espresso will not be drinkable.

The tamping device 4 is made of stainless steel and is heavy. The tamping device 4 includes a rod 41 and a pressing portion 42 connecting to a lower end of the rod 41, and the pressing portion 42 has a flat-bottom. A diameter of the pressing portion 42 mates with that of the filter 3, and the thickness of the pressing portion 42 should be appropriate.

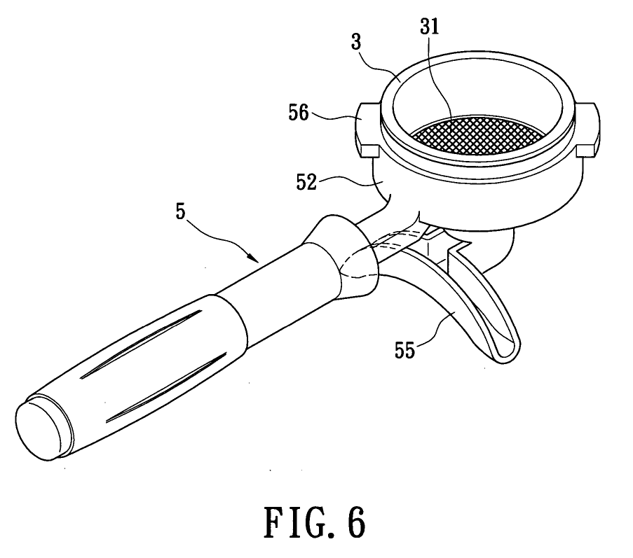

(c) The filter 3 is designed with to a filter holder 5 in a loose mating manner (in FIGS. 5 and 6), the filter holder 5 is attached to the group 21 of the espresso machine 2, and highly pressurized hot water is provided.

The filter holder 5 has a holding portion 51 and a supporting portion 52 connecting to an end of the holding portion 51. The supporting portion 52 has a slot 53 formed on a top thereof, and an exit 54 formed on a bottom thereof and communicating with the slot 53, the exit 54 is adjacent to a flow-guiding member 55, which is disposed beneath the supporting portion 52. An inner diameter of the slot 53 is longer than that of an outer diameter of the filter 3 so that the filter 3 can be disposed in the slot 53 of the filter holder 5 in a loose mating manner. The supporting portion 52 of the filter holder 5 has two opposite buckling portions 56 disposed on a flange thereof, in order to clamp with a buckling slot formed on the group 21 of the espresso machine 2.

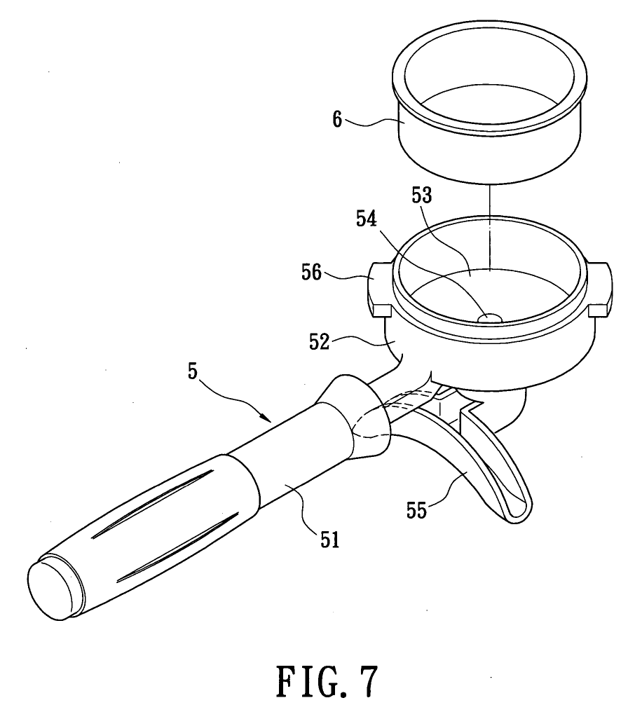

(d) The filter 3 is disassembled from the filter holder 5, and another filter 6 with no holes is disposed on the filter holder 5 in FIG. 7, and the filter holder 5 can be attached to the group 21 of the espresso machine 2 for cleaning the group 21.

The filter 3 mates loosely to the filter holder 5, in order to form a detachable design thereof for easy assembly and disassembly. The filter holder 5 thus can be preheated, and the filter 3 can be kept cool for gaining high quality espresso.

In addition, due to the easy assembly and disassembly of the filter 3 and the filter holder 5, the filter 3 can be changed after every cup of espresso is made; in order to avoid the remaining residual coffee grinds influencing the next cup of the espresso.

The tamping device 4 is heavier than the prior art and the pressing portion 42 has a predetermined thickness so that two fingers can be used to press tops of the pressing portion 42 and the filter 3 simultaneously to feel what if they are in the same horizontal level, and the extent of the tamped ground coffee can be judged more easily and the balance of the tamped ground coffee can be controlled more effortlessly.

The variables in the process for making excellent espresso easily are, according to the present invention, thereby excluded.

Furthermore, it is difficult to train a barista, but the method according to the present invention makes it easier for a barista to learn how to make espresso, so it helps owners of cafes and restaurants as well. Furthermore, the method needs no extra devices or steps so further costs will be incurred.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A method for making espresso comprising:
(a) grinding coffee beans into ground coffee, and putting the ground coffee into a filter, which has a screen formed on a bottom thereof;
(b) tamping the ground coffee evenly via a tamping device; and
(c) arranging the filter in a filter holder in a loose mating manner, attaching the filter holder to a group of an espresso machine and making the espresso with highly pressurized hot water.

2. The method as claimed in claim 1, wherein the step (b) includes sub-steps: pushing the ground coffee aside so that it is flat and uniform, pressing downward with the tamping device, and rotating the tamping device to form the ground coffee into a compact coffee mass.

3. The method as claimed in claim 1, wherein the tamping device in the step (b) is made of metallic materials, the tamping device includes a rod and a pressing portion connecting to a lower end of the rod, and the pressing portion has a flat bottom.

4. The method as claimed in claim 1, further including a step (d): disassembling the filter holder from the filter, taking a filter without any holes on the filter holder, and attaching the filter holder to the group for cleaning.

5. A device for making espresso comprising:
a filter; and
a filter holder having a holding portion and a supporting portion connecting to an end of the holding portion, wherein the supporting portion has a slot formed on a top thereof, and an exit formed on a bottom thereof and communicating with the slot, a diameter of the slot is longer than that of the filter;
wherein the filter is arranged to the filter holder in a loose mating manner.

6. The device as claimed in claim 5, wherein the exit is adjacent to a flow-guiding member, which is disposed beneath the supporting portion.

7. The device as claimed in claim 5, wherein the supporting portion of the filter holder has two opposite buckling portions disposed on a flange thereof.
